(19) United States
(12) Patent Application Publication
(10) Pub. No.: US 2013/0339123 A1
(43) Pub. Date: Dec. 19, 2013

(54) GROUP NATURE VERIFICATION FOR PROVIDING GROUP INCENTIVES

(71) Applicants: Patrick John Ennis, Fall City, WA (US); Alexander Knight, Seattle, WA (US); Vlad Grigore Dabija, Mountain View, CA (US); Timothy Martin Londergan, Seattle, WA (US); Dominic Dan Suciu, Edmonds, WA (US); Raghuram Madabushi, Seattle, WA (US); David Walter Ash, Bellevue, WA (US)

(72) Inventors: Patrick John Ennis, Fall City, WA (US); Alexander Knight, Seattle, WA (US); Vlad Grigore Dabija, Mountain View, CA (US); Timothy Martin Londergan, Seattle, WA (US); Dominic Dan Suciu, Edmonds, WA (US); Raghuram Madabushi, Seattle, WA (US); David Walter Ash, Bellevue, WA (US)

(73) Assignee: Empire Technology Development, LLC., Wilmington, DE (US)

(21) Appl. No.: 13/823,099

(22) PCT Filed: Jun. 19, 2012
(86) PCT No.: PCT/US12/43058

§ 371 Date: Mar. 13, 2013

(51) Int. Cl. G06Q 30/02

(52) U.S. Cl. CPC G06Q 30/0225
USPC 705/14.26

(57) ABSTRACT

Technologies are provided for verifying the group nature of a consumer request to provide a group incentive. In some examples, a consumer may purchase goods and services from a merchant over a network, and may request to take advantage of a group incentive associated with an established group. The merchant may verify that the consumer is a member of the established group before allowing the consumer to receive or use the group incentive. Upon receiving the request associated with the group incentive, the merchant may identify attributes of the consumer and/or the group the consumer claims to belong to. If the attributes match a commonality criterion, the incentive may be authorized. Additionally, the merchant may require a physical appearance of the consumer along with other group members in order to utilize the group incentive.

### BACKGROUND

Unless otherwise indicated herein, the materials described in this section are not prior art to the claims in this application and are not admitted to be prior art by inclusion in this section.

In a consumer environment, businesses and merchants may provide incentives to consumers such as coupons, discount codes, promotion codes, vouchers, and rebates, which the consumers may use when purchasing goods and/or services from the merchant to receive discounted prices. Additionally, merchants may provide group incentives to encourage consumers to purchase goods and/or services as a group. Often times, a merchant may not be able to confirm that the provided group incentives are used by actual group members, and the group incentive codes may be passed around to multiple consumers outside of the group. Without verification that an actual group is seeking a group incentive or a provided group incentive is used my members of the intended, established group, the incentive may not be used for its intended purpose (e.g., customer loyalty), or may even be abused. Additionally, the merchant may want to avoid providing group incentives to a group of consumers who assemble together solely for receiving the benefit of the group incentive.

### SUMMARY

The present disclosure generally describes techniques for enabling merchants to verify a nature of a group for providing group incentives. According to some embodiments, the present disclosure describes a method for enabling merchants to verify a nature of a consumer group for providing a group incentive. The method may include receiving a request associated with the group incentive, determining one or more attributes of consumer group members, comparing the one or more attributes of the consumer group members, and if the attributes of the consumer group members meet a predefined commonality criterion, providing the group incentive.

According to other embodiments, the present disclosure also describes a server for enabling merchants to verify a nature of a consumer group for providing a group incentive. The server may include a memory configured to store instructions, a communication module configured to facilitate communications with one or more consumer computing devices and one or more merchant servers, and a processor configured to execute a group incentive application in conjunction with the instructions stored in the memory. The group incentive application may be configured to enable a merchant to receive a request associated with the group incentive from the consumer group, determine one or more attributes of consumer group members, compare the one or more attributes of the consumer group members, and if the attributes of the consumer group members meet a predefined commonality criterion, provide the group incentive.

According to further embodiments, the present disclosure also includes a computer readable memory device with instructions stored thereon for enabling merchants to verify a nature of a consumer group for providing a group incentive. The instructions may include receiving a request associated with the group incentive from the consumer group, determining one or more attributes of consumer group members, comparing the one or more attributes of the consumer group members, and if the attributes of the consumer group members meet a predefined commonality criterion, providing the group incentive.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 conceptually illustrates an example system for enabling a consumer to utilize a group incentive from a merchant;

FIG. 2 illustrates a scenario for enabling members of a group to utilize a group incentive;

FIG. 3 illustrates an example scenario for enabling an independent administrator to verify the identity of a consumer belonging to a group;

FIG. 4 illustrates a general purpose computing device, which may be used to maintain a registry for enabling merchants to verify the identity of a consumer associated with a group for providing a group incentive;

FIG. 5 is a flow diagram illustrating an example method that may be performed by a computing device such as the computing device in FIG. 4; and

FIG. 6 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to verifying a group nature of a consumer request for providing a group incentive.

Briefly stated, technologies are provided for verifying the group nature of a consumer request to provide a group incentive. A consumer may purchase goods and services from a merchant over a network, and may request to take advantage of a group incentive associated with an established group. The merchant may verify that the consumer is a member of the established group before allowing the consumer to receive or use the group incentive. Upon receiving the request associated with the group incentive, the merchant may identify attributes of the consumer and/or the group the consumer claims to belong to. If the attributes match a commonality criterion, the incentive may be authorized. Additionally, the merchant may require a physical appearance of the consumer along with other group members in order to utilize the group incentive.

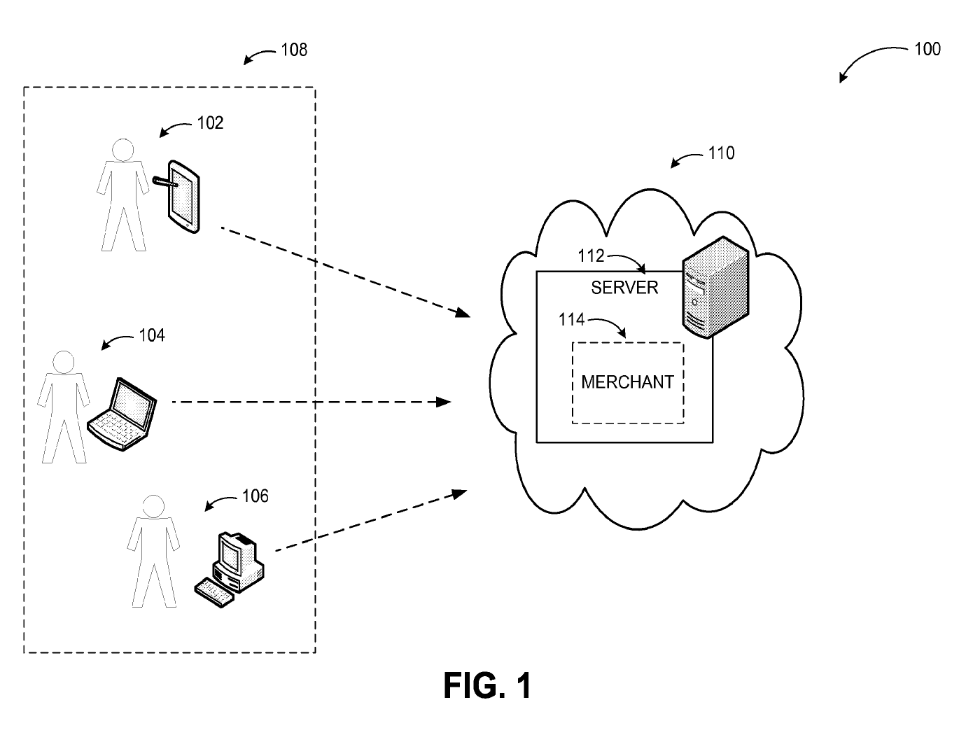

FIG. 1 conceptually illustrates an example system for enabling a consumer to utilize a group incentive from a merchant 114, arranged in accordance with at least some embodiments described herein. In a consumer environment as shown in a diagram 100, businesses and merchants may provide incentives to consumers 102, 104, 106 when purchasing goods and/or services from the merchant 114. Example incentives may include coupons, discount codes, promotion codes, vouchers, and rebates, which the consumers 102, 104, 106 may use when purchasing goods and/or services from the merchant 114 in order to obtain a discounted price from the merchant. Other examples of group incentives may include free or discounted additional merchandise or services (distinct from a purchased item and service).

In some scenarios, the merchant 114 may provide a group incentive to an established group 108 of consumers for enabling the established group 108 to take advantage of the incentive when purchasing from the merchant 114 as a group. The merchant 114 may desire to verify that the group incentive is used by members of the intended established group 108, and may also ensure that the incentive is not used by to consumers who are not members of the established group 108. Additionally, the merchant 114 may wish to confirm that the group incentive is provided to a real established group, rather than a group of individual consumers who may have assembled together solely for receiving the benefit of the group incentive.

An example established group may be formed by members that belong to a family, a social organization, a club, a professional group, a school organization, a religious organization, a social network, a friendship circle, or other similar extracurricular groups. In a further scenario, a pre-identified buying group (i.e., group of friends who agree to buy together) may also be considered an established group if the group meets criteria by a merchant. For example, some merchants may allow buying groups that have been established for a predefined period to buy as a group (to avoid ad hoc get-togethers just for the purpose of obtaining a discount). When the merchant receives a request from a consumer 102 to utilize the group incentive to purchase goods and/or services, the merchant 114 may verify that the consumer 102 is a member of is the established group 108 to which the merchant has provided the group incentive for ensuring that the group incentive 114 is utilized by members of the intended established group 108. In other examples, the confirmation may be provided by the group itself. For example, a social group such as an alumni association may certify that people who are attempting to receive a discount or other incentive as an established group are indeed its members to the merchant providing the incentive.

In an example scenario, the merchant 114 may provide goods and/or services, which may be purchased by one or more consumers 102, 104, 106 over a network 110, such as a wireless or wired network. A server 112 associated with the network 110 may host a platform, such as a web commerce application, for enabling the consumers 102, 104, 106 to purchase goods and/or services from the merchant 114 over the network. For example, the merchant 114 may be an online merchant such that the consumer may connect with the server 112 via a browser on the consumer's personal computing device and may purchase the goods and/or services over the network 110. Example goods and/or services may include tangible items that may be delivered to the consumer, event tickets, such as movie and concert tickets, restaurant vouchers, and other provided services such as automobile detailing and maintenance, home cleaning and maintenance, personal care, and pet care to name a few.

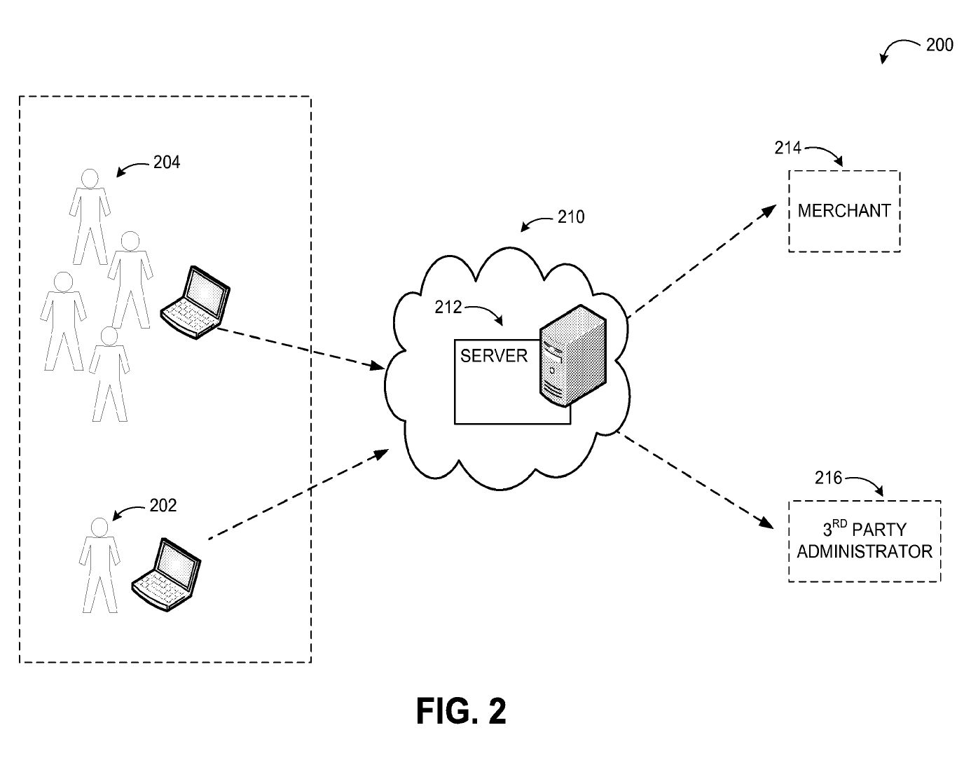

FIG. 2 illustrates a scenario for enabling members of a group to utilize a group incentive, arranged in accordance with at least some embodiments described herein. In a similar manner as previously discussed in conjunction with FIG. 1, a merchant 214 may verify an individual consumer is a member of an established group 204 for ensuring that a group incentive provided by the merchant 214 is utilized by members of the intended established group 204. In an example embodiment, the merchant 214 may receive a request over a network 210 to purchase goods and/or services provided by the merchant 214 by a consumer 202. The consumer 202 may request to utilize a group incentive, which may have been previously provided to the established group 204 by the merchant 214. The merchant 214 may determine if the consumer 202 is a member of the established group 204 to which the merchant 214 has previously provided the group incentive before allowing the consumer 202 to utilize the group incentive. In order to determine if the consumer 202 is a member of the established group 204, the merchant 214 may identify characteristics or attributes of the consumer 202, and may determine if the identified attributes of the consumer 202, such as a physical address, location, and/or email address, for example, match identified attributes of the established group 204 (e.g., addresses of other members, etc.).

For example, the established group 204 may be a professional organization, such as a group of co-workers, who may all have an email address sharing a common domain name (e.g. @workplace.com). If the merchant 214 provides the group incentive to the members of the professional organization, then the merchant 214 may verify that the consumer's email address shares the common domain name with the professional organization. If the merchant 214 verifies that the consumer 202 is a member of the professional organization by identifying a common domain name in the email address, the merchant 214 may then enable the consumer 202 to utilize the group incentive.

In another example scenario shown in a diagram 200, the merchant 214 may utilize an attribute such as a physical address and/or location of the consumer 202 to determine if the consumer is a member of the established group 204. The merchant 214 may identify a physical address associated with the consumer 202 via a manual input of the consumer's address by the consumer 202. In another example, the merchant 214 may utilize a location application to identify the physical location of the consumer 202 at the time of the request. The merchant 214 may determine if the physical address and/or location associated with the consumer 202 at the time of the request matches a physical address and/or location associated with the established group 204 in order to confirm that the consumer 202 is a member of the established group 204.

In another example embodiment, the merchant 214 may compare other attributes of the established group 204 with consumer attributes to determine if the consumer 202 is a member of the established group 204. For example, the merchant 214 may determine if the consumer 202 is a member of a group on a social network which is associated with the group incentive. Additionally, the merchant 214 may determine if the consumer 202 is a member of the established group 204 based on a payment method provided by the consumer 202. For example, if the consumer 202 utilizes a payment method, such as a group credit card or group account, that has been previously associated with the established group 204, then the merchant 214 may verify that the consumer 202 is a member of the established group 204. In a further example, the merchant 214 may use a facial scanning application to determine if the consumer 202 is a member of the established group 204. When the consumer makes a purchase request with the group incentive over the network 210, the merchant 214 may use facial scanning via a camera associated with the consumer's computing device to verify the identity of the consumer 202. Alternatively, the merchant 214 may require that at least a predefined number of members of the group are present when the group incentive is authorized such as physical presence or confirmation through facial scanning during a video conference at the time of purchase, etc.

In a further embodiment, when the consumer 202 makes a request to purchase goods or services which may require the physical attendance of the consumer 202, such as tickets to an event or a meal at a restaurant, for example, the merchant 214 may verify that the consumer is a member of the established group 204 by requiring the consumer to attend with other members of the established group 204. For example, if the request is for a meal voucher at a restaurant, the consumer may be required to arrive at the restaurant with one or more other members of the established group 204. In another example, if the event is one requiring seating assignments, the merchant 214 may assign the consumer 202 a ticket within a section of tickets to the established group 204 such that each member of the established group is assigned adjacent seats. Further, if seating assignments are not required or available, the merchant 214 may require the consumer 202 to arrive at in advance with one or more other members of the established group 204 in order to retrieve the tickets for admission to the event. Additionally, the merchant 214 may utilize two or more group verification methods for increasing the confidence of the verification. For example, the merchant 214 may utilize facial scanning as well as email address and/or physical address comparison, and also may require two or more group members to appear together if purchasing goods or services requiring physical attendance.

In yet another embodiment, a third party administrator 216 may monitor a request by the consumer 202 to purchase goods and/or services utilizing a group incentive. The third party administrator 216 may detect a request to purchase goods or services from the merchant 214 utilizing a group incentive, and the third party administrator 216 may verify that the consumer 202 is a member of the established group 204 to which the merchant 214 has previously provided the group incentive. As previously described, the third party administrator 216 may compare attributes of the requesting consumer with identified attributes of the established group 204 in order to verify that the consumer is a member of the established group. For example, the third party administrator 216 may compare a domain name of an email address associated with the consumer 202 with a domain name of the established group 204, and the third party administrator 216 may also compare a physical address and location of the consumer 202 and the established group 204. Additionally, the third party administrator 216 may use other similar methods as the merchant 214 for verifying the consumer as a member of the established group, such as facial scanning, requiring advance attendance, and assigning group tickets.

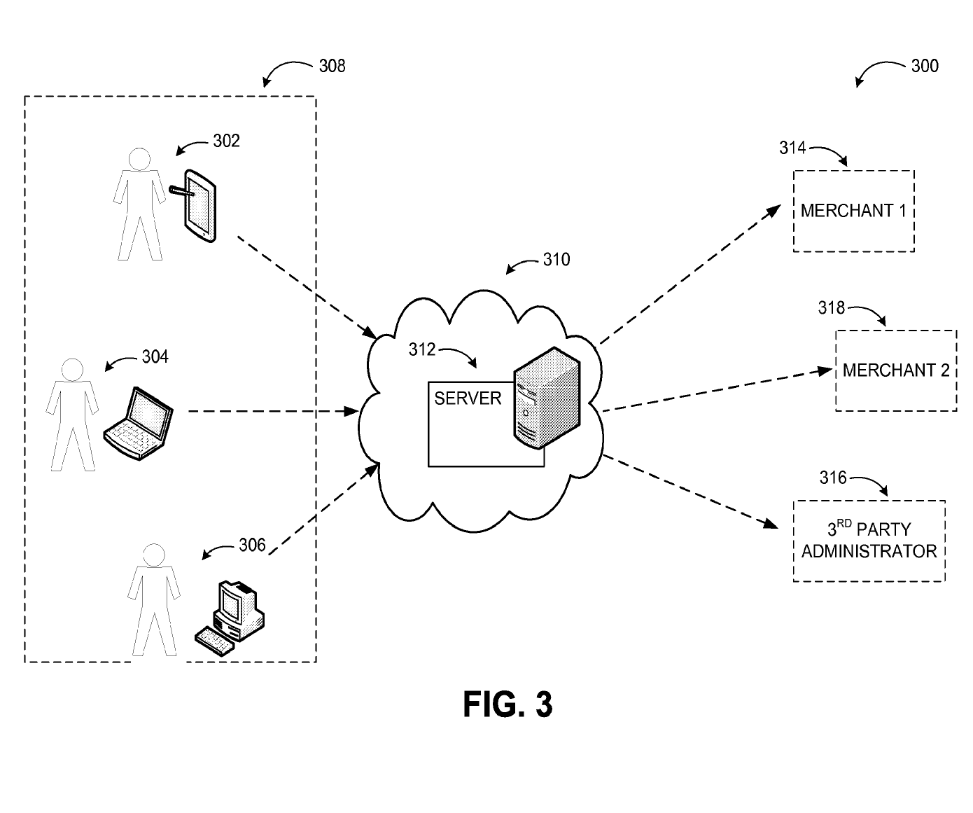

FIG. 3 illustrates an example scenario for enabling an independent administrator to verify the identity of a consumer belonging to a group, arranged in accordance with at least some embodiments described herein. In a similar manner as previously described in conjunction with FIG. 2, a merchant 314 may verify that a consumer 302 requesting to utilize a group incentive is a member of an established group 308 to which the merchant 314 has provided a group incentive. The merchant 314 may receive a request over a network 310 to utilize the group incentive, and upon receipt of the request, the merchant 314 may perform a variety of verification methods to ensure the group nature of the consumer. A third party administrator 316 associated with the merchant 314 may also be utilized for ensuring the group nature of the consumer. Upon receipt of the request to utilize the group incentive, the merchant 314 and/or the third party administrator 316 may verify that the consumer 302 is a member of an established group 308 to which the merchant 314 has previously provided the group incentive.

In an example embodiment shown in a diagram 300, the consumer 302 may be verified as a member of the established group 308 by comparing attributes of the consumer with identified attributes of the established group 308. For example, attributes such as a domain name of an email address, a location, and a social network group may be compared. Additionally, facial scanning may be performed by the merchant 314 and the third party administrator 316 to confirm that the consumer is a member of the established group 308. In another example, the merchant 314 and the third party administrator 316 may determine if the request is submitted using a payment method associated with the established group 308.

In a further embodiment, the merchant 314 and the third party administrator 316 may verify the consumer 302 is a member of the established group 308 associated with the group incentive by comparing the consumer's current request with previous requests by the consumer 302. For example, when the consumer 302 utilizes a group incentive associated with the established group 308, and the merchant verifies that the consumer 302 is a member of the established group 308, the merchant 314 may store the group verification for future use. When the consumer 302 makes a subsequent request to utilize another group incentive associated with the established group 308, the merchant 314 and/or the third party administrator 316 may access the stored group verification information associated with the consumer to verify that the consumer is a member of the established group 308. The merchant 314 and/or the third party administrator 316 may access stored group verification information to compare a current request with previous requests to the same merchant 314, and additionally, the merchant 314 and/or the third party administrator 316 may compare group verification information with previous requests to another merchant 316 who may have stored group verification information for the consumer 302 and the associated established group 308.

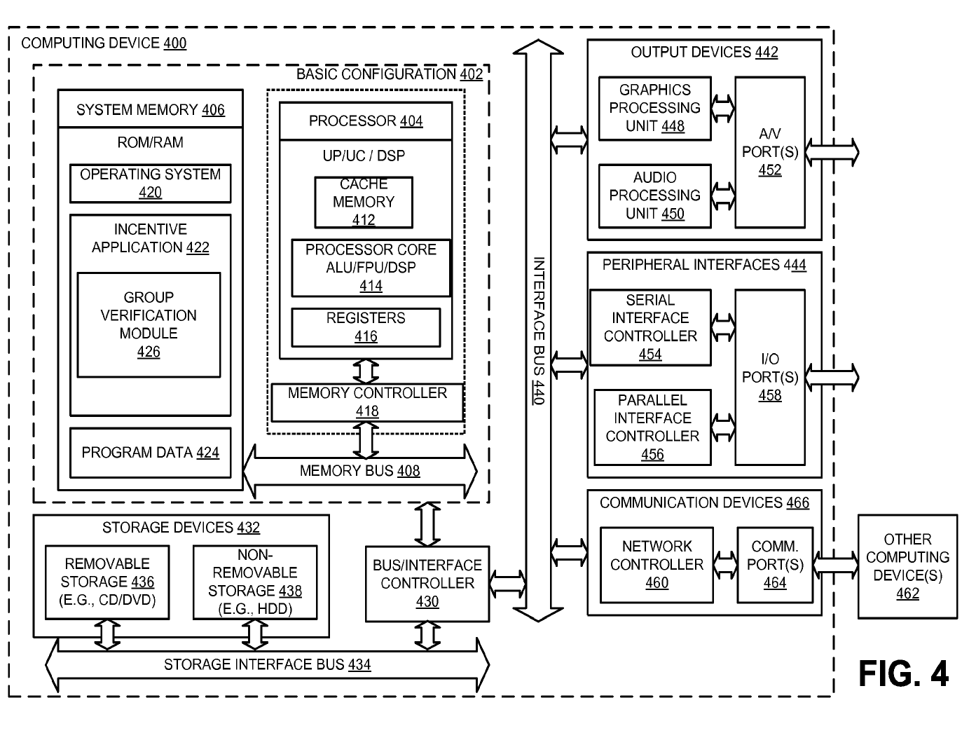

FIG. 4 illustrates a general purpose computing device, which may be used to maintain a registry for enabling merchants to verify the identity of a consumer associated with a group for providing a group incentive. In a very basic configuration 402, computing device 400 typically includes one or more processors 404 and a system memory 406. A memory bus 408 may be used for communicating between processor 404 and system memory 406.

Depending on the desired configuration, the processor 404 may be of any type including but not limited to a microprocessor (μP), a microcontroller (μC), a digital signal processor (DSP), or any combination thereof. The processor 404 may include one more levels of caching, such as a level cache memory 412, a processor core 414, and one or more registers 416. An example processor core 414 may include an arithmetic logic unit (ALU), a floating point unit (FPU), a digital signal processing core (DSP Core), or any combination thereof. An example memory controller 418 may also be used with the processor 404, or in some implementations the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420, one or more applications 422, and program data 424. The application 422 may include a group verification module 426 that is arranged to detect a request to utilize a group incentive from a consumer and verify that the consumer is a member of an established group associated with the group incentive. Program data 424 may include consumer attributes and group attributes data, and similar data. The program data 424 may be useful in comparing the attributes of the consumer with the established group for confirming that the consumer is a member of the established group. This described basic configuration 402 is illustrated in FIG. 4 by those components within the inner dashed line.

The computing device 400 may have additional features or functionality, and additional interfaces to facilitate communications between the basic configuration 402 and any required devices and interfaces. For example, a bus/interface controller 430 may be used to facilitate communications between the basic configuration 402 and one or more data storage devices 432 via a storage interface bus 434. The data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (e.g., output devices 442, peripheral interfaces 444, and communication devices 446) to the basic configuration 402 via the bus/interface controller 430. Example output devices 442 include a graphics processing unit 448 and an audio processing unit 450, which may be configured to communicate to various external devices such as a display or speakers via one or more A/N ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 400 may also be implemented as a personal computer including both laptop computer and non-laptop computer configurations. Moreover the computing device 400 may be implemented as a networked system or as part of a general purpose or specialized server.

Example embodiments may also include methods. These methods can be implemented in any number of ways, including the structures described herein. One such way is by machine operations, of devices of the type described in the present disclosure. Another optional way is for one or more of the individual operations of the methods to be performed in conjunction with one or more human operators performing some of the operations while other operations are performed by machines. These human operators need not be collocated with each other, but each can be only with a machine that performs a portion of the program. In other examples, the human interaction can be automated such as by pre-selected criteria that are machine automated.

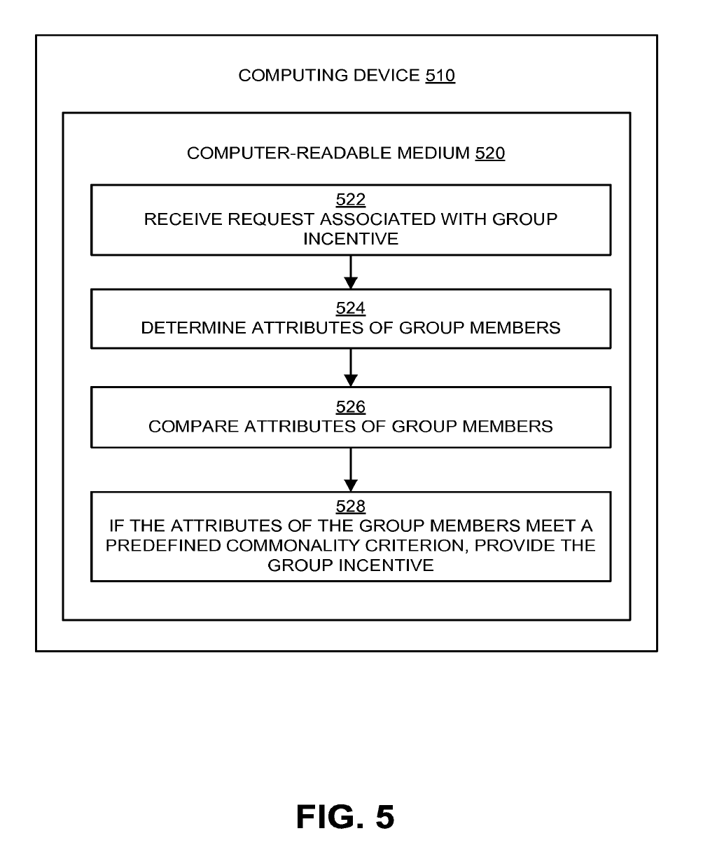

FIG. 5 is a flow diagram illustrating an example method that may be performed by a computing device such as the computing device in FIG. 4, arranged in accordance with at least some embodiments described herein.

Example methods may include one or more operations, functions or actions as illustrated by one or more of blocks 522, 524, 526 and/or 528. The operations described in blocks 522 through 528 may also be stored as computer-executable instructions in a computer-readable medium such as a computer-readable medium 520 of a computing device 510.

A process for verifying the group nature of a consumer request to utilize a group incentive may begin with block 522, “RECEIVE REQUEST ASSOCIATED WITH GROUP INCENTIVE.” At block 522, a merchant may receive a request from a consumer to utilize a group incentive associated with an established group. The request may be to purchase goods and/or services from the merchant over a network.

Block 522 may be followed by block 524, “DETERMINE ATTRIBUTES OF GROUP MEMBERS.” At block 524, the merchant may identify attributes of the consumer making the request and attributes of the established group. Example attributes may include a domain name of an email address, a physical address and/or location, a payment method, and other similar identifying characteristics.

Block 524 may be followed by block 526, “COMPARE ATTRIBUTES OF GROUP MEMBERS.” At block 526, merchant may compare the identified attributes of the consumer making the request with the identified attributes of the established group associated with the group incentive.

Block 526 may be followed by block 528, “IF ATTRIBUTES OF GROUP MEMBERS MEET A PREDEFINED COMMONALITY CRITERION, PROVIDE THE GROUP INCENTIVE.” At block 528, the merchant may determine if the identified attributes of the consumer making the request match identified attributes of the established group associated with the group incentive. For example, if the domain name of the email address associated with the consumer matches the domain name of the email address associated with the established group, then the consumer may be verified as a member of the group and may be allowed to utilize the group incentive. Additionally the steps of blocks 522 through 528 may be performed by a third party administrator responsible for monitoring requests to utilize group incentives by a consumer and verifying that the consumer is a member of the established group associated with the group incentive.

The blocks included in the above described process are for illustration purposes. Verifying the group nature of a consumer request to utilize a group incentive may be performed by similar processes with fewer or additional blocks. In some examples, the blocks may be performed in a different order. In some other examples, various blocks may be eliminated. In still other examples, various blocks may be divided into additional blocks, or combined together into fewer blocks. Although illustrated as sequentially ordered operations, in some implementations the various operations may be performed in a different order, or in some cases various operations may be performed at substantially the same time.

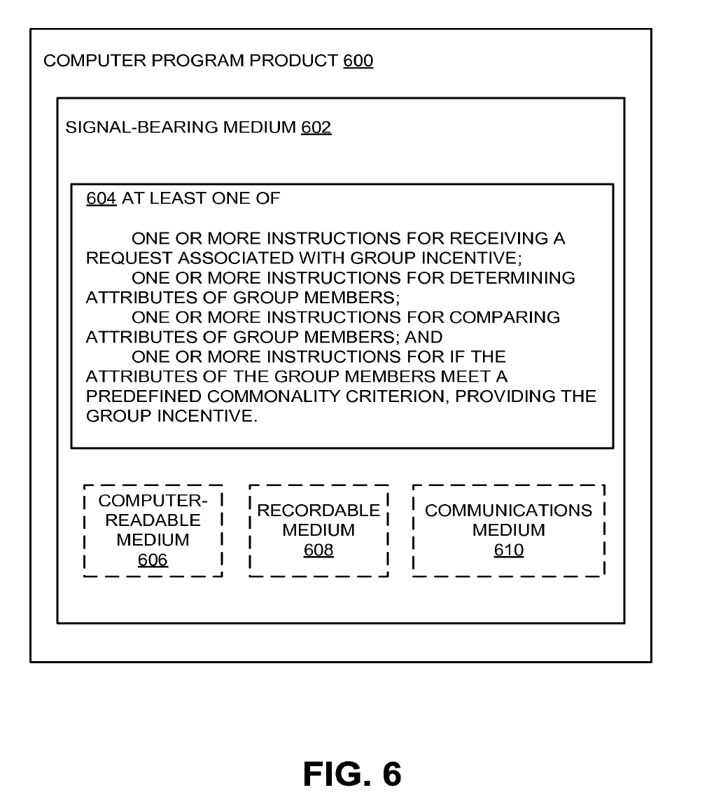

FIG. 6 illustrates a block diagram of an example computer program product, arranged in accordance with at least some embodiments described herein. In some examples, as shown in FIG. 6, a computer program product 600 may include a signal bearing medium 602 that may also include machine readable instructions 604 that, when executed by, for example, a processor, may provide the functionality described above with respect to FIG. 4 and FIG. 5. Thus, for example, referring to the processor 404, the group verification module 426 may undertake one or more of the tasks shown in FIG. 4 in response to instructions 604 conveyed to processor 404 by the signal bearing medium 602 to perform actions associated with verifying the group nature of a consumer request to utilize a group incentive as described herein. Some of those instructions may include receiving a request associated with a group incentive, determining attributes of group members, comparing attributes of the group members, and if the attributes of the group members meet a predefined commonality criterion, providing the group incentive.

In some implementations, the signal bearing medium 602 depicted in FIG. 6 may encompass a computer-readable medium 606, such as, but not limited to, a hard disk drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, the program product 600 may be conveyed to one or more modules of the processor 404 by an RF signal bearing medium, where the signal bearing medium 602 is conveyed by a wireless communications medium 610 (e.g., a wireless communications medium conforming with the IEEE 802.11 standard).

The present disclosure describes a method for enabling merchants to verify a nature of a consumer group for providing a group incentive. The method may include receiving a request associated with the group incentive, determining one or more attributes of consumer group members, comparing the one or more attributes of the consumer group members, and if the attributes of the consumer group members meet a predefined commonality criterion, providing the group incentive.

According to some embodiments, the one or more attributes may include: a domain of consumer group member email addresses and/or physical addresses of the consumer group members. The one or more attributes may further include: an employer, a school organization, a social network group, a club, a religious organization, an extracurricular organization, and/or a social organization of the consumer group members.

According to some embodiments, the method may include increasing a confidence level in the verification of the nature of the consumer group by comparing two or more attributes. The method may also include determining if the request is submitted using a payment method associated with the consumer group. The method may further include if the group incentive is associated with an event providing seating assignments, verifying the consumer group is assigned adjacent seats.

According to some embodiments, the method may include requiring the consumer group members to arrive at the event a predefined period in advance of the event for providing the group incentive. The method may also include if the request is submitted online, verifying the nature of the consumer group through facial scanning of the consumer group members.

According to other embodiments, the method may further include verifying the nature of the consumer group by comparing the request with one or more previous requests by the consumer group. The method may also include if the nature of the consumer group is verified, storing the verification for future requests by the consumer group.

According to some embodiments, the group incentive may be associated with a group activity other than a requested activity. The verification of the nature of the consumer group may be performed by one of: an independent third party or a merchant fulfilling the request. The group incentive may be received from the consumer group. According to other embodiments, the present disclosure also describes a server for enabling merchants to verify a nature of a consumer group for providing a group incentive. The server may include a memory configured to store instructions, a communication module configured to facilitate communications with one or more consumer computing devices and one or more merchant servers, and a processor configured to execute a group incentive application in conjunction with the instructions stored in the memory. The group incentive application may be configured to enable a merchant to receive a request associated with the group incentive from the consumer group, determine one or more attributes of consumer group members, compare the one or more attributes of the consumer group members, and if the attributes of the consumer group members meet a predefined commonality criterion, provide the group incentive.

According to some embodiments, the one or more attributes may include: a domain of consumer group member email addresses and/or physical addresses of the consumer group members. The one or more attributes may further include: an employer, a school organization, a social network group, a club, a religious organization, an extracurricular organization, and/or a social organization of the consumer group members. The group incentive application may be further configured to increase a confidence level in the verification of the nature of the consumer group by comparing two or more attributes.

According to some embodiments, the group incentive application may be further configured to determine if the request is submitted using a payment method associated with the consumer group.

According to some embodiments, the group incentive application may be further configured to if the group incentive is associated with an event providing seating assignments, verify the consumer group is assigned adjacent seats. The group incentive application may be further configured to require the consumer group members to arrive at the event a predefined period in advance of the event for providing the group incentive.

According to other embodiments, the group incentive application may be further configured to if the request is submitted online, verify the nature of the consumer group through facial scanning of the consumer group members. The group incentive application may be further configured to verify the nature of the consumer group by comparing the request with one or more previous requests by the consumer group.

According to other embodiments, the group incentive application may be further configured to if the nature of the consumer group is verified, store the verification for future requests by the consumer group. The group incentive may be associated with a group activity other than a requested activity. The server may be part of a system operated by one of: an independent third party or a merchant fulfilling the request. The group incentive may be received from the consumer group.

According to further embodiments, the present disclosure also includes a computer readable memory device with instructions stored thereon for enabling merchants to verify a nature of a consumer group for providing a group incentive. The instructions may include receiving a request associated with the group incentive from the consumer group, determining one or more attributes of consumer group members, comparing the one or more attributes of the consumer group members, and if the attributes of the consumer group members meet a predefined commonality criterion, providing the group incentive.

According to some embodiments, the one or more attributes may include: a domain of consumer group member email addresses and/or physical addresses of the consumer group members. The one or more attributes may further include: an employer, a school organization, a social network group, a club, a religious organization, an extracurricular organization, and/or a social organization of the consumer group members.

According to some embodiments, the instructions may further include increasing a confidence level in the verification of the nature of the consumer group by comparing two or more attributes. The instructions may further include determining if the request is submitted using a payment method associated with the consumer group.

According to some embodiments, the instructions may further include if the group incentive is associated with an event providing seating assignments, verifying the consumer group is assigned adjacent seats. The instructions may also include requiring the consumer group members to arrive at the event a predefined period in advance of the event for providing the group incentive. The instructions may further include if the request is submitted online, verifying the nature of the consumer group through facial scanning of the consumer group members.

According to some embodiments, the instructions may further include verifying the nature of the consumer group by comparing the request with one or more previous requests by the consumer group. The instructions may also include, if the nature of the consumer group is verified, storing the verification for future requests by the consumer group.

According to further embodiments, the group incentive may be associated with a group activity other than a requested activity. The verification of the nature of the consumer group may be performed by one of: an independent third party or a merchant fulfilling the request. The group incentive may be received from the consumer group.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for enabling merchants to verify a nature of a consumer group for providing a group incentive, the method comprising:
receiving a request associated with the group incentive;
determining one or more attributes of consumer group members;
comparing the one or more attributes of the consumer group members;
increasing a confidence level in the verification of the nature of the consumer group by comparing two or more attributes; and
in response to determination that the attributes of the consumer group members meet a predefined commonality criterion, providing the group incentive.

2. The method of claim 1, wherein the one or more attributes include: a domain of consumer group member email addresses and/or physical addresses of the consumer group members.

3. The method of claim 1, wherein the one or more attributes further include: an employer, a school organization, a social network group, a club, a religious organization, an extracurricular organization, and/or a social organization of the consumer group members.

4. (canceled)

5. The method of claim 1, further comprising:
determining if the request is submitted using a payment method associated with the consumer group.

6. The method of claim 1, further comprising:
in response to determination that the group incentive is associated with an event providing seating assignments, verifying the consumer group is assigned adjacent seats.

7. The method of claim 6, further comprising:
requiring the consumer group members to arrive at the event a predefined period in advance of the event for providing the group incentive.

8. The method of claim 1, further comprising:
in response to determination that the request is submitted online, verifying the nature of the consumer group through facial scanning of the consumer group members.

9. The method of claim 1, further comprising:
verifying the nature of the consumer group by comparing the request with one or more previous requests by the consumer group.

10-13. (canceled)

14. A server for enabling merchants to verify a nature of a consumer group for providing a group incentive, the server comprising:
a memory configured to store instructions;
a communication module configured to facilitate communications with one or more consumer computing devices and one or more merchant servers; and
a processor configured to execute a group incentive application in conjunction with the instructions stored in the memory, wherein the group incentive application is configured to:
enable a merchant to receive a request associated with the group incentive from the consumer group;
determine one or more attributes of consumer group members;
compare the one or more attributes of the consumer group members;
increase a confidence level in the verification of the nature of the consumer group by comparing two or more attributes; and
in response to determination that the attributes of the consumer group members meet a predefined commonality criterion, provide the group incentive.

15. The server of claim 14, wherein the one or more attributes include: a domain of consumer group member email addresses and/or physical addresses of the consumer group members.

16-22. (canceled)

23. The server of claim 14, wherein the group incentive application is further configured to:
in response to determination that the nature of the consumer group is verified, store the verification for future requests by the consumer group.

24. The server of claim 14, wherein the group incentive is associated with a group activity other than a requested activity.

25. The server of claim 14, wherein the server is part of a system operated by one of: an independent third party or a merchant fulfilling the request.

26. The server of claim 14, wherein the group incentive is received from the consumer group.

27. A computer readable memory device with instructions stored thereon for enabling merchants to verify a nature of a consumer group for providing a group incentive, the instructions comprising:
receiving a request associated with the group incentive from the consumer group;
determining one or more attributes of consumer group members;
comparing the one or more attributes of the consumer group members;
increasing a confidence level in the verification of the nature of the consumer group by comparing two or more attributes; and
in response to determination that the attributes of the consumer group members meet a predefined commonality criterion, providing the group incentive.

28. (canceled)

29. The computer readable memory device of claim 27, wherein the one or more attributes further include: an employer, a school organization, a social network group, a club, a religious organization, an extracurricular organization, and/or a social organization of the consumer group members.

30-31. (canceled)

32. The computer readable memory device of claim 27, wherein the instructions further comprise:
in response to determination that the group incentive is associated with an event providing seating assignments, verifying the consumer group is assigned adjacent seats.

33-35. (canceled)

36. The computer readable memory device of claim 27, wherein the instructions further comprise:
in response to determination that the nature of the consumer group is verified, storing the verification for future requests by the consumer group.

37. The computer readable memory device of claim 27, wherein the group incentive is associated with a group activity other than a requested activity.

38. The computer readable memory device of claim 27, wherein the verification of the nature of the consumer group is performed by one of: an independent third party or a merchant fulfilling the request.

39. (canceled)
